(19) United States
(12) Patent Application Publication
(10) Pub. No.: US 2002/0043776 A1
(43) Pub. Date: Apr. 18, 2002

(54) Mobile machinary base

(76) Inventor: Bor Yann Chuang, Taichung (TW)

Correspondence Address: DOUGHERTY & TROXELL, SUITE 1404, 5205 LEESBURG PIKE, FALLS CHURCH, VA, 22041, US

(21) Appl. No.: 09/989,158

(22) Filed: Nov. 21, 2001

(51) Int. Cl. B62D 61/12

(52) U.S. Cl. 280/43.24

(57) ABSTRACT

A mobile machinery base includes a case, two caster wheels provided under rear corners of the bottom of the case, two adjustable feet with gaskets to stand on or leave the ground, and a liftable caster wheel assembly connected to a center portion of one side of the bottom of the case. An object to be moved is placed on an upper surface of the case, which has a structural strength enough for supporting heavy objects to be moved. A hang frame is fixed under the bottom of the case, connected to a fixing frame having two lateral plates. Then, if a pedal of the liftable caster wheel assembly is pressed down, the fixing frame with the adjustable feet is lifted up to leave the ground, permitting the caster wheel of the liftable caster wheel assembly contact the ground to let the mobile machinery base freely move around on the ground.

### BACKGROUND OF THE INVENTION

This invention relates to a mobile machinery base, particularly to one having a simple structure for easy handling to move heavy tool cases, woodworking, metalworking or other machines.

A conventional mobile machinery base disclosed in a U.S. Pat. No. 5,785,293 is configured to a predetermined shape and dimensions by providing four beam members of a predetermined length to connect four corner brackets that define the corners of the mobile machinery base. But the corner brackets are complicated to form, wasting much labor for connecting the corner brackets with the beam members. In addition, the wood beam members cannot connect with an object to be placed on and only deposited on, easily causing wrong movement and falling off of the object placed on.

### SUMMARY OF THE INVENTION

The main objective of the invention is to offer a mobile machinery base, which includes a case, a predetermined number of caster wheels affixed at corners of the bottom of the case, some adjustable feet with gaskets to stand on or leave the ground, and a liftable caster wheel, reinforcing the strength of the whole structure to secure safety in handling.

Another objective of the invention is to offer a mobile machinery base, which has a hang frame provided on the bottom of the case, a fixing frame having two lateral plate to connect with the hang frame. When a pedal of the liftable caster wheel is pressed down, a slanting plate of the stationary frame is lifted upward, pushing up the hang frame so as to stabilize the mobile machinery base on the ground to move around, with the strength of the structure of the mobile machinery base reinforced.

### BRIEF DESCRIPTION OF DRAWINGS

This invention will be better understood by referring to the accompanying drawings, wherein:

FIG. 1 is a perspective view of a mobile machinery base in the present invention;

FIG. 2 is side view of the mobile machinery base with a pedal not pressed down in the present invention;

FIG. 3 is an exploded perspective view of the mobile machinery base in the present invention;

FIG. 4 is partial cross-sectional view of the hang frame in the present invention; and,

FIG. 5 is a side view of the mobile machinery base with the pedal pressed down in the present invention.

### DETAILED DESCRIPTION OF THE PREFERRED EMBODIMENT

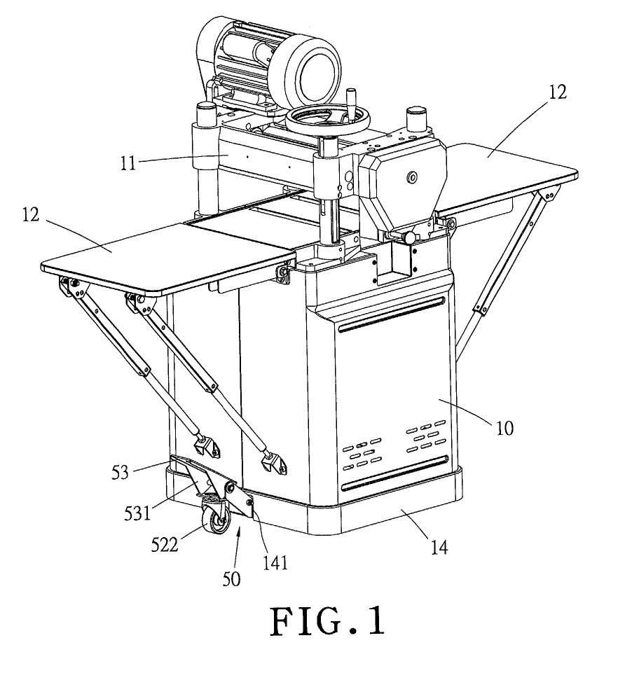

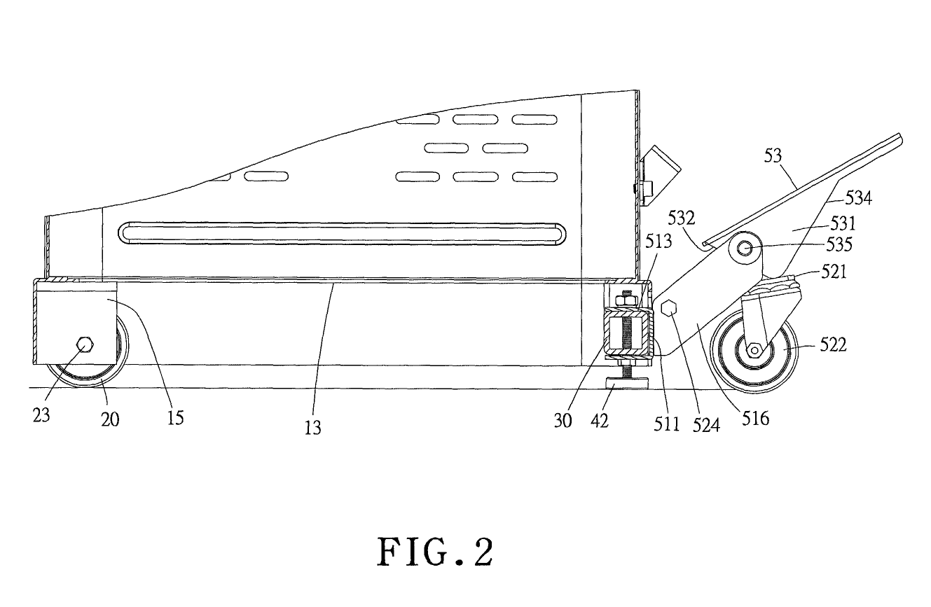

A preferred embodiment of a mobile machinery base in the present invention, as shown in FIGS. 1 and 2, includes a case member 10 made of metal and having a rectangular shape, two caster wheels 20 connected under corners of the case 10, a hang frame 30, two adjustable feet with gaskets 40, and a liftable caster wheel assembly 50, as main components combine together.

An upper surface of the case member 10 serves for receiving the bottom of an object to be moved, such as a machine table 11 of a planing machine also having an extension plate 12 at two sides of the machine table 11 for supporting wood to be planed.

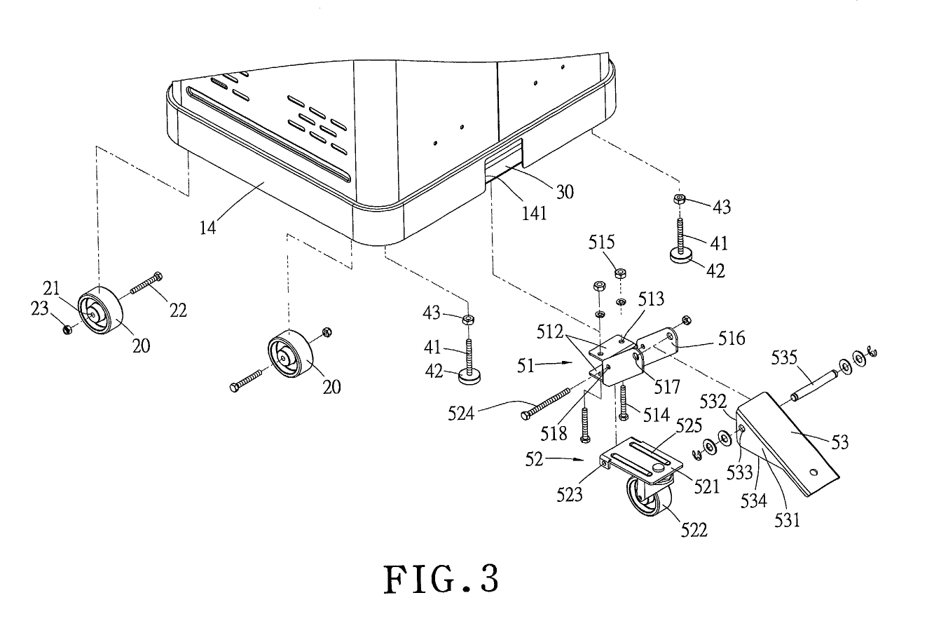

The case member 10 also has a bottom plate 13, a vertical circumferential frame 14 provided to surround the bottom plate 13, as shown in FIG. 3. Two caster wheels 20 are fixed respectively under two corners of a rear side of the bottom plate 13, respectively having a shaft hole 21 in the center for a bolt 22 and a nut 23 to fix the two caster wheels 20 on two stationary plates 15. Further, a window 141 is provided in the center of a side of the circumferential frame 14.

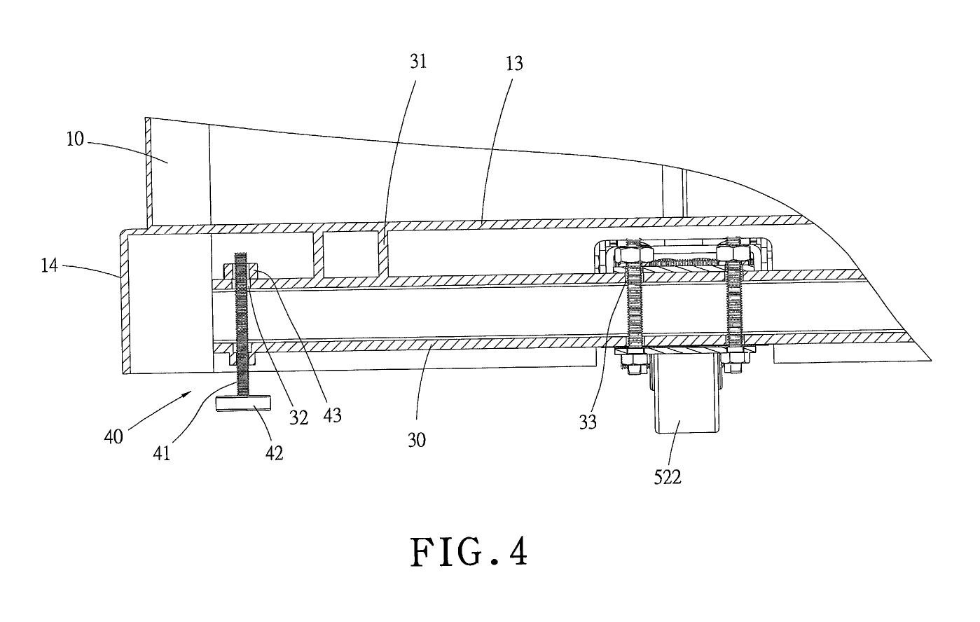

The hang frame 30 is a hollow elongate rectangle, made of metal as shown in FIG. 4, having two projections 31 on top fixed at a front side of the bottom plate 13, two first fixing holes 32 formed in opposite ends and two second fixing holes 33 formed in an intermediate portion and spaced apart with a preset distance.

The two adjustable feet 40 respectively have a threaded rod portion 41, a gasket portion 42 connected to the end of the threaded rod portion 41 and a nut 43 welded firmly on top of the first fixing hole 32 of the hang frame 30 and engaging with the threaded rod portion 41 screwing through the first fixing hole 32. Then the height of the adjustable feet 42, possible to stand on or leave the ground, is adjusted by how long the threaded rod portion 41 screws up so that the case 10 may be stabilized firmly on the ground, not swaying around at all.

The liftable caster wheel assembly 50 consists of a fixing frame 51, a caster wheel plate 52, a caster wheel 522, and a pedal 53. The fixing frame 51 has a center lengthwise plate 511, two lateral plates 512 connected with an upper and a lower end of the center lengthwise plate 512, two fixing holes 513 bored in the two lateral plates 512 and facing the two fixing holes 33 for two screws 514 to secure through each set of aligned holes and then screw with nuts 515 tightly. Then the two lateral plates 512 are fixed firmly on top and bottom of the intermediate portion of the hang frame 30. Further, two slanting plates 516 are positioned at two outer sides of the center lengthwise plate 511, slanting with a preset angle and spaced apart, having a shaft hole 517 bored symmetrically in the upper end of the slanting plates 516 and a locking hole 518 bored in a lower end. Besides, as shown in FIG. 1, the two slanting plates 516 protrude out of the window 141 of the circumferential frame 14.

The caster wheel plate 52 has a fixing plate 521 in an upper side, and the caster wheel 522 connected under the fixing plate 521. The fixing plate 521 has two symmetrical locking holes 523 bored in a rear side of the fixing plate 521, which is then fixed firmly on the slanting plates 516, rotating with a shaft and having two parallel slide slots 525 formed in an upper surface.

The pedal 53 has two triangular control plates 531 fixed under two opposite sides of the front end, and each control plate 531 has a shaft hole 533 bored in an upper portion near the front edge 532, letting the distance between the shaft hole 533 and the bottom edge 534 being larger than that between the shaft hole 533 and the front edge 532. A shaft 535 protrudes the shaft hole 533 and through the shaft holes 517 of the slanting plates 516. The corners of the two control plates 531 fit and slide in the two parallel slots 525 of the fixing plate 521.

Next, how to handle the mobile machinery base and mutual movement of the components are to be described. When the pedal 53 is not pressed down, as shown in FIG. 2, the two caster wheels 20 in the rear side and the two adjustable feet 40 contact the ground, with the mobile machinery base positioned on the ground. At this condition, the height of the two adjustable feet 40 may be adjusted by screwing the threaded rods 41 until the case 10 becomes stable on the ground without swaying around at all.

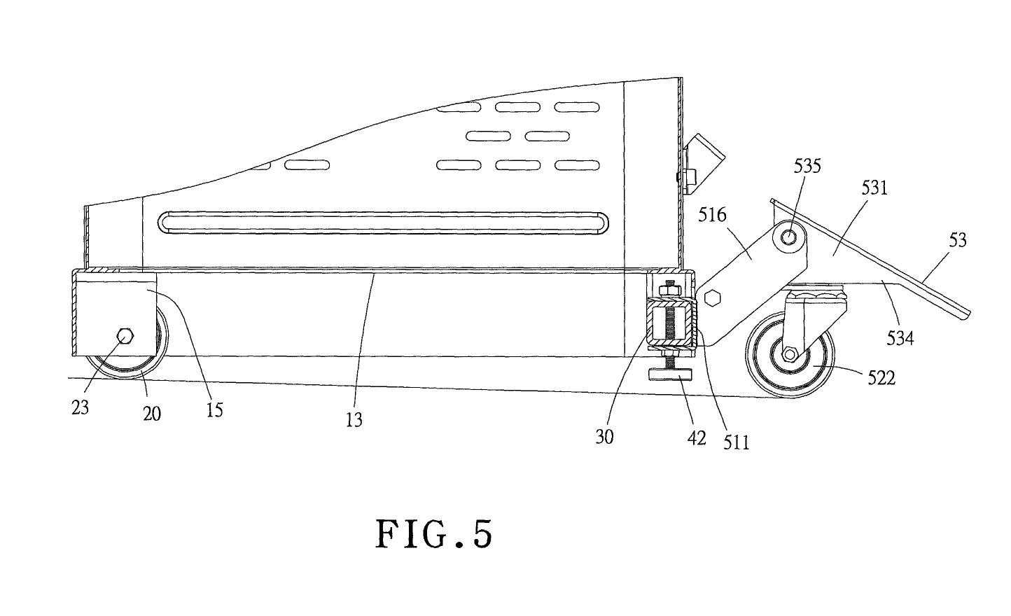

Now referring to FIG. 5, if the pedal 53 is pressed down, the pedal 53 and the two triangular control plates 531 rotate with the pin 535 as a shaft until the bottom edge 534 contacts the control plates 531, pressing the caster wheel 522 of the liftable caster wheel assembly 50 to contact the ground owing to the larger distance between the shaft hole 533 and the bottom edge than that of the shaft hole 533 and the front edge 532, lifting upward the slanting plates 516 and the two adjusting feet 40 to leave the ground, with the casters wheel 522 and the two caster wheels 20 all contact the ground to permit the mobile machinery base move around freely.

The case 10 is reinforced in its whole structure by adding the two caster wheels 20 and two adjusting feet 40 and the liftable caster wheel assembly 50.

The invention does not use beam members and corner brackets of complicated structure used in the conventional one described above, having more safety than the conventional one.

Moreover, pressing down of the pedal 53 is practically lifting the slanting plates 516, and thus raising the hang frame 30 at the bottom of the case 10. Therefore, the design of the slanting plates 516 of the fixing frame 51 and connecting structure of the lateral plate 512 and the hang frame 30 can intensify the strength of the whole structure.

While the preferred embodiment of the invention has been described above, it will be recognized and understood that various modifications may be made therein and the appended claims are intended to cover all such modifications that may fall within the spirit and scope of the invention.

I claim:

1. A mobile machinery base comprising a case, a plurality of caster wheels provided under a rear side of a bottom of said case, and adjustable feet provided under corners of a bottom surface of said case, and,
Characterized by a liftable caster wheel assembly connected to a hang frame fixed at a predetermined position of the bottom of said case, said liftable caster wheel assembly having a fixing frame fixed with the bottom of said case, a caster wheel plate pivotally connected with said fixing frame said caster wheel plate having a fixing plate formed in an upper portion, and a caster wheel connected under said fixing plate, a pedal pivotally connected to one end of said fixing frame, said adjustable feet lifted up and leaving the ground in case of said pedal being pressed down so that said mobile stationery base may freely move around on the ground.

2. The mobile machinery base as claimed in claim 1, wherein two slanting plates are further provided at two outer sides of said fixing frame, having a predetermined angle and spaced apart, a shaft hole bored symmetrically in an upper end and connected to said pedal with a shaft, and a lock hole bored in a lower end to pivotally connect said fixing plate of said caster wheel plate.

3. The mobile machinery base as claimed in claim 1, wherein the hang frame is further provided under the bottom of said case, two lateral plates are connected to an upper and a lower end of said fixing frame of said liftable caster wheel assembly, and fixed firmly on said hang frame.

4. The mobile machinery base as claimed in claim 1, wherein a bottom plate is further provided under the bottom of said case, and a vertical circumferential frame is formed around said bottom plate.

5. The mobile machinery base as claimed in claim 4, wherein said vertical circumferential frame has a window at a preset location, for said two slanting plates to protrude out.

6. The mobile machinery base as claimed in claim 1, wherein said fixing plate of said caster wheel plate has two parallel slide slots formed in an upper surface, said pedal has two triangular control plates respectively provided vertically under two opposite sides of a front end, and corners of the two control plates fit and slide in said two parallel slots
